(19) United States
(12) Patent Application Publication
(10) Pub. No.: US 2020/0331451 A1
(43) Pub. Date: Oct. 22, 2020

(54) VEHICLE SYSTEMS WITH CONTEXT BASED DYNAMIC POWER SAVING

(71) Applicant: Byton North America Corporation, Santa Clara, CA (US)

(72) Inventor: Eric Money, San Jose, CA (US)

(21) Appl. No.: 16/389,640

(22) Filed: Apr. 19, 2019

(51) Int. Cl. B60W 20/13; B60W 10/08

(52) U.S. Cl. CPC B60W 20/13; B60W 2710/244; B60W 2710/083; B60W 10/08

(57) ABSTRACT

Vehicle systems with context based dynamic power savings are disclosed. For one example, a vehicle data processing system includes a telematics subsystem, one or more sensors and a vehicle controller unit (VCU). The telematics subsystem receives map data for a vehicle. The one or more sensors receive sensor data related to the vehicle or user of the vehicle. The VCU is coupled to the telematics subsystem and one or more sensors. The VCU can change a torque limit for an electric motor of the vehicle based on a context derived from the received map data or sensor data. The VCU can enter a mode for dynamic power savings and set the torque limit to a lower base limit from a higher base limit to conserve power consumption.

### FIELD

Embodiments of the invention are in the field of electric power and control systems for vehicles using electric motors. More particularly, embodiments of the invention relate to vehicle systems with context based dynamic power saving.

### BACKGROUND

Electric powered vehicles are gaining popularity due to its use of clean energy. Such vehicles have electric motors which can be powered by rechargeable batteries. Electric motors receive power from a battery to generate torque causing the wheels to rotate and move the vehicle. Electric vehicles can consume large amounts of power during high torque demand events such as merging onto a highway from an on-ramp or passing another vehicle on the highway. Electric vehicles, in contrast, can consume lower amounts of power during low torque demand events such as going down an on-ramp or moving slowly in rush hour traffic. Drivers of electric vehicles, however, may increase acceleration exacting a higher torque demand when a lower acceleration or decreased torque demand should be used, e.g., during a steady-state vehicle operation such as moving at a constant speed on a highway. This unnecessary use of high torque demand should be avoided to conserve battery power for electric vehicles.

### SUMMARY

Embodiments and examples are disclosed of vehicle systems with context based dynamic power saving. For one example, a vehicle data processing system includes a telematics subsystem, one or more sensors and a vehicle controller unit (VCU). The telematics subsystem receives map data for a vehicle. The one or more sensors receive sensor data related to the vehicle or user of the vehicle. The VCU is coupled to the telematics subsystem and one or more sensors. The VCU can change a torque limit for an electric motor receiving power from a battery of the vehicle based on a context derived from the received map data or sensor data. The torque limit can be lowered or clipped to reduce overall peak power consumed by the electric motor while maintaining driving capabilities.

For one example, the VCU enters a mode to change the torque limit including reducing the torque limit from a higher base limit to a lower base limit for dynamic power saving and power consumption conservation. This power conservation is a result of clipping the torque limit or peak power potential to a lower base limit such that power at a higher base limit is not consumed by the electric motor from the battery. For one example, the VCU can detect any number of contexts to enter this mode for dynamic power saving. One example context can indicate a low torque demand event such as a vehicle entering an on-ramp to a highway. Other example contexts can indicate a high torque demand event such as a vehicle leaving an on-ramp to merge on to a highway. In this context, the VCU can temporarily set the torque limit back to the higher base limit to handle the high torque demand event. After the high torque demand event, the VCU can reset the torque limit back to the lower base limit in the mode for dynamic power savings. The VCU can detect any number of contexts indicating a low torque demand event or a high torque demand event using the received map data and sensor data.

Other systems, apparatuses, methods, computer readable-mediums and vehicles are described.

### BRIEF DESCRIPTION OF THE DRAWINGS

The appended drawings illustrate examples and embodiments and are, therefore, exemplary and not considered to be limiting in scope.

FIG. 1 illustrates one example of a vehicle environment for a vehicle to implement context based dynamic power saving.

FIG. 2 illustrates one example of a block diagram of interconnected subsystem nodes on a network bus.

FIG. 3A illustrates one example block diagram of a data processing system of a vehicle to implement context based dynamic power savings.

FIG. 3B illustrates one example diagram of a contexts table stored in a memory.

FIG. 4A illustrates one example of a flow diagram of a dynamic power saving operation in a mode for dynamic power savings.

FIG. 4B illustrates another example of a flow diagram of a dynamic power saving operation in a mode for dynamic power savings.

FIG. 4C illustrates one example of a diagram of a highway with on-ramps and off-ramps and points for entering an on-ramp and leaving an off-ramp by a vehicle.

FIG. 5 illustrates one example of a block diagram of a dynamic power saving state machine.

FIG. 6 illustrates one example of a flow diagram of an operation of the dynamic power saving state machine of FIG. 5 in the active state.

FIGS. 7A-7D illustrates example flow diagrams of an operation of the dynamic power saving state machine of FIG. 5 operating in the inactive state.

### DETAILED DESCRIPTION

The following detailed description provides embodiments and examples of vehicle systems providing context based dynamic power saving. For one example, a vehicle data processing system includes a telematics subsystem, one or more sensors and a vehicle controller unit (VCU). The telematics subsystem receives map data for a vehicle. The one or more sensors receive sensor data related to the vehicle or user of the vehicle. The VCU is coupled to the telematics subsystem and one or more sensors. The VCU can change a torque limit for an electric motor receiving power from a battery of the vehicle based on a context derived from the received map data or sensor data. The VCU can enter a mode for dynamic power savings and change the torque limit including reducing the torque limit from a higher base limit to a lower base limit. Such clipping or lowering the torque limit in certain contexts can have a number of benefits including power conservation while maintaining driving capabilities for a vehicle. Drivers who use the acceleration pedal or function excessively or higher than average (e.g., having a lead-foot) can also benefit as a portion of the high-power demand above the lowered torque limit is not used and conserved.

For one example, the VCU can receive map data and detect a context and determine a low torque demand event such as the vehicle entering an on-ramp to a highway where high acceleration is not needed. In this context, the VCU can enter into a mode for dynamic power saving and lower the maximum base torque limit (e.g., 200 newton meter (Nm)) of a vehicle to a lower base limit (e.g., 100 Nm). For other examples, there can be multiple lower base limits to reach a lowest base limit, e.g., 175 Nm, 150 Nm to 100 Nm, which can be set in varying time intervals or instances. In this way, power consumption can be conserved such that the unnecessary power can be limited from use in contexts where a low torque or acceleration is required. For one example, map data can be received by a telematics subsystem of the vehicle. The map data can also be used to identify that the vehicle is about to change contexts, e.g., merge onto the highway from the on-ramp. For one example, in this changed context, the VCU can override the mode for dynamic power savings and temporarily set the torque limit back to the maximum or higher base limit, e.g., 200 Nm, and afterwards return to the mode for dynamic power savings, e.g., if traffic on the highway is at a standstill, and set the torque limit back to the lower base limit, e.g., 100 Nm. By entering into a mode for dynamic power savings, the VCU can control the maximum amount of torque needed by electric motor and conserve power when in low torque demand contexts and raise the torque limit when in high torque demand contexts. Other contexts can be used to dynamically control the torque limit as disclosed herein.

As set forth herein, various embodiments, examples and aspects will be described with reference to details discussed below, and the accompanying drawings will illustrate various embodiments and examples. The following description and drawings are illustrative and are not to be construed as limiting. Numerous specific details are described to provide a thorough understanding of various embodiments and examples. However, in certain instances, well-known or conventional details are not described to facilitate a concise discussion of the embodiments and examples.

### Exemplary Vehicle with Context Based Dynamic Power Saving

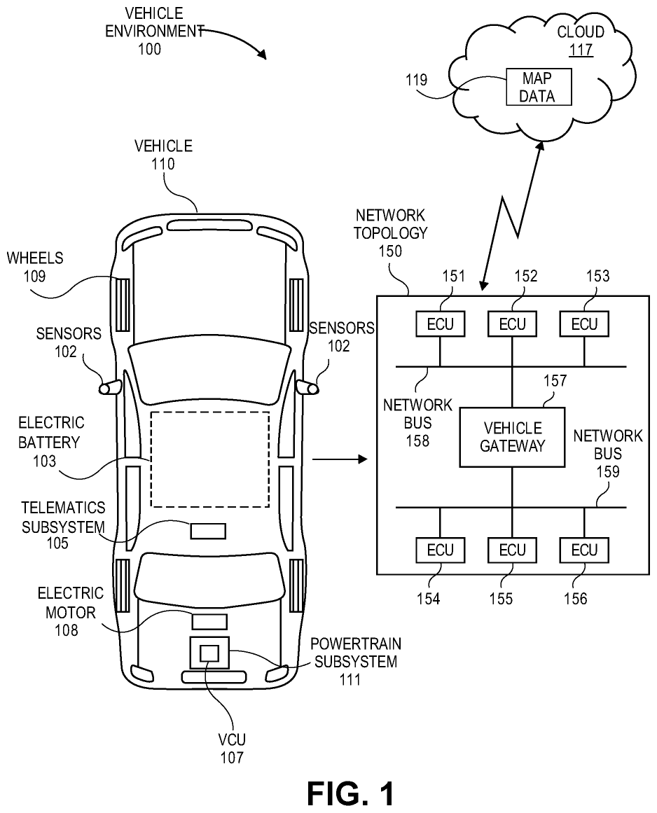

FIG. 1 illustrates one example of a vehicle environment 100 for a vehicle 110 to implement context based dynamic power saving. Vehicle 110 can be a non-autonomous, semi-autonomous or autonomous electric car or sports utility vehicle (SUV) implementing power saving and conservation techniques disclosed herein. For one example, vehicle 110 includes sensors 102, battery 103, telematics subsystem 105, electric motor 108 and a powertrain subsystem 111 including a vehicle controller unit (VCU) 107. Electric motor 108 receives power from battery 103 to generate torque that turn wheels 109 and move vehicle 110. Referring to FIG. 1, although vehicle 110 is shown with one electric motor 108 powered by electric battery 103 for a two-wheel drive implementation, vehicle 110 can have a second electric motor for a four-wheel drive implementation. In this example, electric motor 108 is located at the rear of vehicle 110 to drive back wheels 109 as a two-wheel drive vehicle. For other examples, another electric motor can be placed at the front of vehicle 110 to drive front wheels 109 as a four-wheel drive vehicle implementation.

Examples of electric motor 108 can include an alternating current (AC) induction motors, brushless direct-current (DC) motors, and brushed DC motors. For one example, electric motor 108 can include a rotor having magnets that rotate around an electrical wire or a rotor having electrical wires that can rotate around magnets. For other examples, electric motor 108 can include a center section holding magnets for a rotor and an outer section having coils. When driving wheels 109, for example, electric motor 108 can connect with electric battery 103 providing an electric current on the wire that creates a magnetic field to move the magnets in the rotor that generates torque to drive wheels 109. For one example, electric battery 103 can be a 120V or 240V rechargeable battery to power electric motor 108 or other electric motors for vehicle 110. Examples of electric battery 104 can include lead-acid, nickel-cadmium, nickel-metal hydride, lithium ion, lithium polymer, or other types of rechargeable batteries. For one example, electric battery 103 can be located on the floor and run along the bottom of vehicle 110. Electric battery 103 can be located in any location of vehicle 110.

For one example, within vehicle 110, any number of subsystems or subsystem nodes can be implemented to control vehicle functions such as telematics subsystem 105 and powertrain subsystem 111. Each of these subsystems can include electronic control units (ECUs) which can be interconnected as illustrated by interconnected ECUs 151-156 on network busses 158 and 159 within a network topology 150 having a vehicle gateway 157. For example, powertrain subsystem 111 can control electric motor 108 and wheels 109 based on commands or signals from VCU 107, which can be an ECU such as ECUs 151-156 in network topology 150. VCU 107 or ECUs 151-156 can be a micro-controller coupled to memory storing code to control components and implement respective functions for vehicle 110. VCU 107 can be coupled to other ECUs or subsystems including telematics subsystem 105 and sensors 102, which can have respective ECUs. For one example, vehicle gateway 157 can include a micro-controller, central processing unit (CPU), or processor or be a computer and data processing system to coordinate communication on network topology 150 between the ECUs 151-156 and VCU 107. For one example, vehicle gateway 157 interconnects groups (or networks) and can coordinate communication between a group of ECUs 151-153 with another group of ECUs 154-156 on busses 158 and 159. For one example, network topology 150 and busses 158 and 159 can support messaging protocols including Controller Area Network (CAN) protocol, Local Interconnect Protocol (LIN), and Ethernet protocol.

For one example, telematics subsystem 105 can include one or more ECUs to aggregate connectivity within vehicle 110 and with external networks such as cloud 117. For example, telematics subsystem 105 can include a global positioning system (GPS) or a wireless connection system or one or more modems to communicate with cloud 117 including map data 119. For one example, cloud 117 can include GPS satellites providing GPS data and map data 119 can include GPS data and location data for vehicle 110 to traverse a mapped area. Telematics subsystem 104 can support communication protocols such as, e.g., Global System for Mobile Communications (GSM), General Packet Radio Service (GPRS), CDMAOne, CDMA2000, Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/TDMA), Integrated Digital Enhance Network (iDEN), etc. and protocols including IEEE 802.11 wireless protocols, long-term evolution LTE 3G+ protocols, and Bluetooth and Bluetooth low energy (BLE) protocols.

For one example, sensors 102 can include at least a surround or stereo camera, light detection and ranging device (LIDAR), ultrasonic devices, inertia measurement unit (IMU), and/or global positioning device (GPS). Sensors 102 including a surround or stereo camera can capture image data surrounding the vehicle including surrounding roads, objects or persons, and road signs. Although sensors 102 are shown outside of vehicle 110, one or more cameras can be placed within vehicle 110 to take images of a driver or a passenger. Sensors 102 including a LIDAR can measure distance to the designated object by illuminating the designated object with a laser. Sensors 102 including an ultrasonic device can detect objects and distances using ultrasound waves. Sensors 102 including an IMU can collect angular velocity and linear acceleration data, and the GPS device can obtain GPS data and calculate geographical positioning of the vehicle using map data 119 from cloud 117. Sensors 102 can also include brake sensors and temperature sensors at various components within vehicle 110. Map data 119 and data from sensors 107 can be forwarded to the powertrain subsystem 111 including VCU 107 to detect contexts to enter a mode for dynamic power savings.

For one example, powertrain subsystem 111, including VCU 107, can detect any number of contexts using map data 119 and sensor data from sensors 102 to enter a mode for dynamic power savings. In this mode, VCU 107 can change a maximum torque limit for electric motor 108 to a lower base limit or temporarily reset the torque limit to the maximum torque limit. For example, VCU 107 can detect a context such as vehicle 110 approaching an on-ramp to a highway to indicate a low torque demand event using map data 119 including GPS data. In this low torque demand event, vehicle 110 does not require high torque or acceleration for electric motor 108 and VCU 107 can enter a mode for dynamic power savings and change the maximum torque limit (e.g., 200 Nm) to a lower base (e.g., 100 Nm) for electric motor 108 to use. Likewise, VCU 107 can use map data 119 including GPS data to detect a context such as vehicle 110 leaving the on-ramp to merge on to the highway indicating a high torque demand. In this high demand torque event, VCU 107 can override the mode for dynamic power savings and temporarily raise the torque limit back to the maximum torque limit, e.g., 200 Nm. Once a stable context is detected, e.g., a steady-state condition when the high torque demand event is no longer needed such as vehicle 100 moving at a constant speed, VCU 107 can change the maximum torque limit back to the lower base limit, e.g., 100 Nm.

For other examples, VCU 107 can determine other contexts by using sensor data from sensors 102 such as sensing or detecting that surrounding vehicles around vehicle 110 are not moving or moving slowly indicating that vehicle 110 may be in rush hour traffic and determine that a high torque demand is not needed. Alternatively, VCU 107 can detect that vehicle 110 is going up a hill and determine that a high torque demand is required. VCU 107 can detect any number of contexts using map data 119 and sensor data from sensors 102 in determining a low torque demand event for changing the torque limit to a lower base limit for conserving power. The VCU 107 can also determine a high torque demand event for temporarily raising the torque limit as needed for high acceleration requirements.

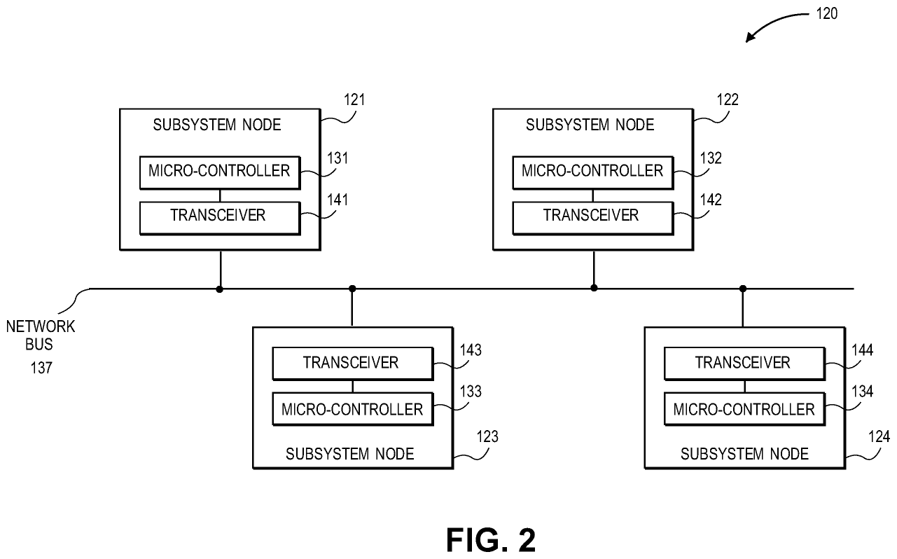

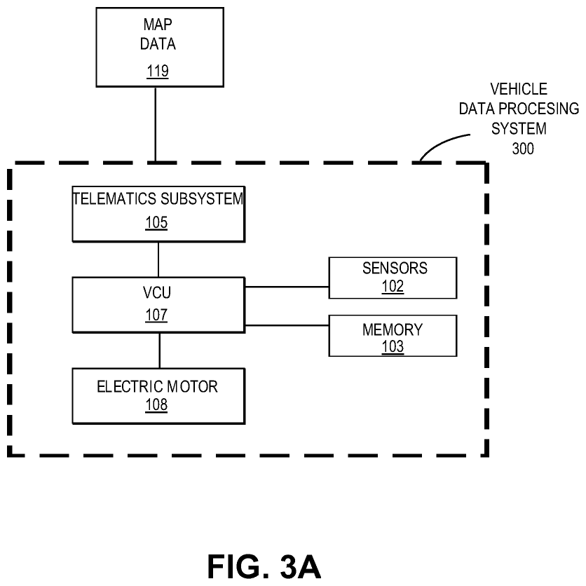

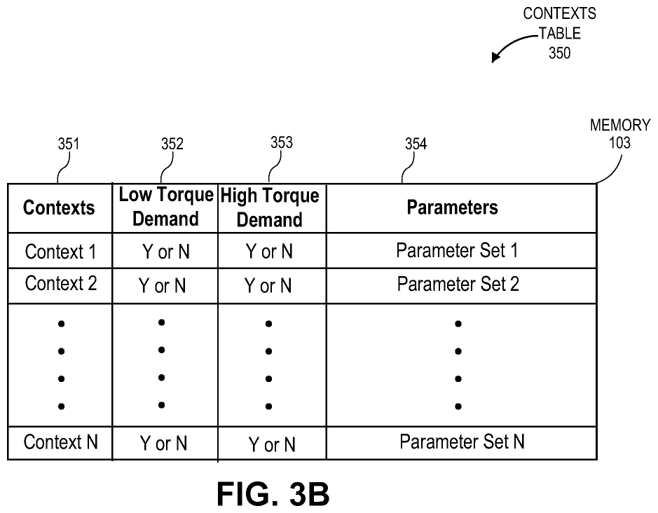

FIG. 2 illustrates one example of a block diagram 120 of interconnected subsystem nodes 121-124 on network bus 137, which can represent subsystems operating within vehicle 110 such as telematics subsystem 105 and powertrain subsystem 111 or vehicle gateway 127 in FIG. 1. Powertrain subsystem 111 can also include electric motor 108, which can also be a subsystem or subsystem node. Referring to FIG. 2, although four subsystem nodes are shown, any number of subsystem nodes can be implemented for vehicle 110. Each of the subsystem nodes 121-124 includes respective transceivers 141-144 and micro-controllers 131-134. Each of the subsystem nodes 121-124 are coupled to network bus 137, which can support any type of vehicle network, e.g., a CAN, LIN or Ethernet network. For example, transceivers 141-144 can support data messaging according to the ISO 11898-1, ISO/AWI 17987-8 and IEEE 802.11 protocols. Micro-controllers 131-134 can control vehicle components, functions or services and communicate with other subsystems or subsystem nodes. For other examples, network bus 137 is coupled to a vehicle gateway 127 and subsystem nodes 121-124 are coupled to vehicle gateway 127 or, alternatively, a subsystem node can be a vehicle gateway 127. The micro-controllers 131-134 can run firmware or program code to control vehicle components and related functions. For one example, VCU 107 can be part of one of the subsystem nodes 121-124 to perform power saving operations as described in FIGS. 3A-7D.

### Exemplary Vehicle Data Processing System for Dynamic Power Savings

FIG. 3A illustrates one example block diagram of a vehicle data processing system 300 to implement context based dynamic power saving. For one example, vehicle data processing system 300 includes VCU 107 coupled to telematics subsystem 105, electric motor 107, sensors 102 and memory 103 as described in FIG. 1. For one example, memory 103 can be any type or number of non-volatile, volatile or a non-transitory computer-readable media to store program code or firmware executed by VCU 107 or other data to perform the dynamic power savings operations described herein. For other examples, memory 103 can include a database storing a context table 350 as shown in FIG. 3B. Memory 103 can store map data 119 including GPS data and sensor data from sensors 102 to be processed or analyzed by VCU 107. For one example, VCU 107 is part of powertrain subsystem 111 to send signals and control electric motor 108 as shown in FIG. 1. For example, VCU 107 can communicate signals to electric motor 108 to set torque limits and parameters for electric motor 108 to operate differently under certain contexts. In setting torque limits, VCU 107 can determine contexts by using map data 119 and sensor data from sensors 102 and context table 350 in memory 103 to detect contexts for raising or lowering the maximum base torque limit for electric motor 108 to drive wheels 109.

For one example, VCU 107 initially sets the torque limit for electric motor 108 to its maximum base, e.g., 200 Nm. This can be the torque limit for normal operation of vehicle 110. For one example, VCU 107 can enter a mode for dynamic power savings either manually by a user or by VCU 107 detecting a context using context table 350 indicating low torque demand events. For example, contexts table 350 includes any number contexts 351 (Context 1 to N) in which one of the contexts can be a low torque demand event 352 having parameters 354 such as location, speed, road type, speed limit, traffic and sensor information etc. indicating, e.g., vehicle 110 is approaching an on-ramp to a highway or other low torque demand event 352. For one example, VCU 107 can analyze received map data 119 and sensor data from sensors 102 to determine if the map and sensor data is within the parameters 354 for such a context indicating a low torque demand event that requires low acceleration in contrast to high acceleration. For another example, vehicle 107 can use an image from a camera taking a picture of a speed limit sign recognizing it as a 15 to 25 mile an hour zone as a parameter requiring minimal torque or acceleration. Motion sensors can also inform VCU 107 that vehicle 110 is in rush hour traffic by detecting minimal or no motion of nearby vehicles within parameters 354 indicating low torque demand event requiring minimal torque or acceleration. For such a low torque demand event, VCU 107 can enter a mode for dynamic power savings to clip or lower the torque limit to a lower base limit, e.g., from 200 Nm to 100 Nm. For one example, VCU 107 can set intervals of lower base limits to reach 100 Nm e.g., 175 Nm, 150 Nm, 125 Nm to 100 Nm.

For one example, VCU 107 can analyze received map data 119 and sensor data from sensors 102 to detect a context by determining if the map and sensor data is within the parameters 354 for a high torque demand event, e.g., vehicle 110 leaving the on-ramp and merging on to the highway requiring high torque or acceleration. In this context, if vehicle 110 is operating in a mode for dynamic power savings, VCU 107 can temporarily override the mode and raise the torque limit to its maximum base limit, e.g., from 100 Nm to 200 Nm. For one example, VCU 107 can raise the torque limit in intervals to reach 200 Nm, e.g., 100 Nm, 125 Nm, 150 Nm, 175 Nm to 200 Nm. Other contexts for high torque demand events 353 can be based on parameters 354 indicating electric battery 103 temperature exceeding a threshold, internal cabin temperature of vehicle 110 exceeding a threshold, kick-down pedal event such as vehicle 110 operating in cruise control in which high acceleration may be required.

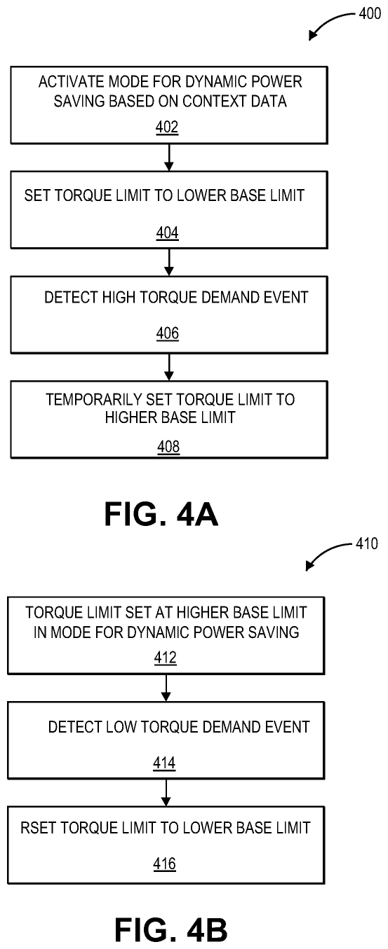

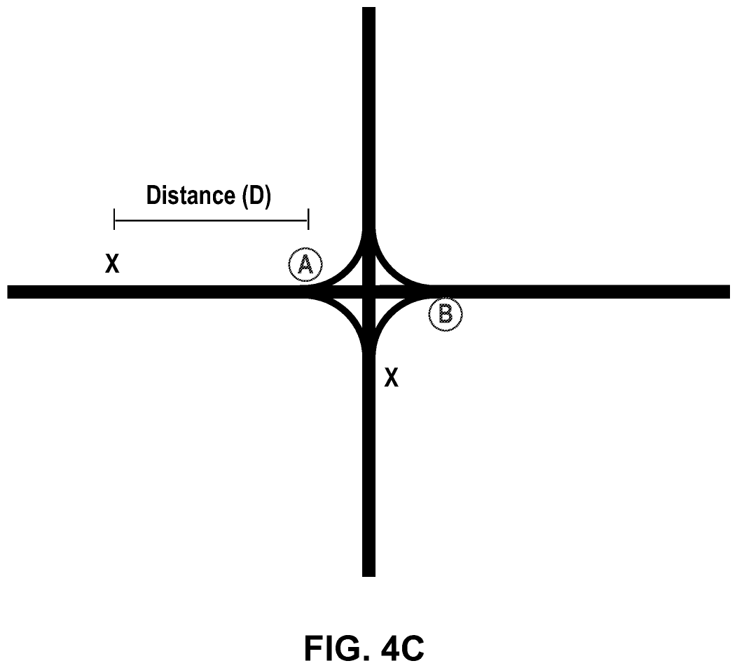

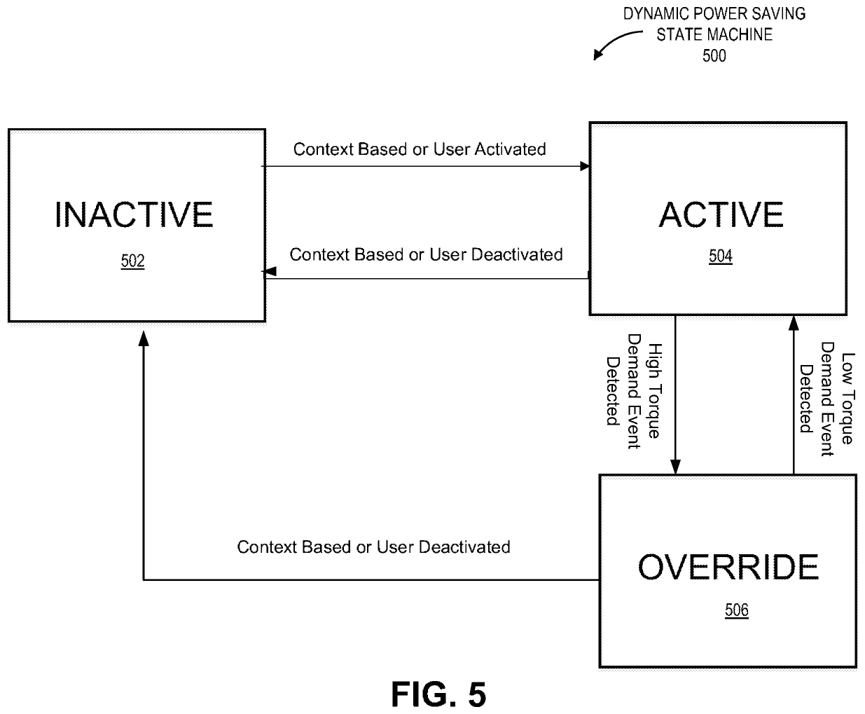

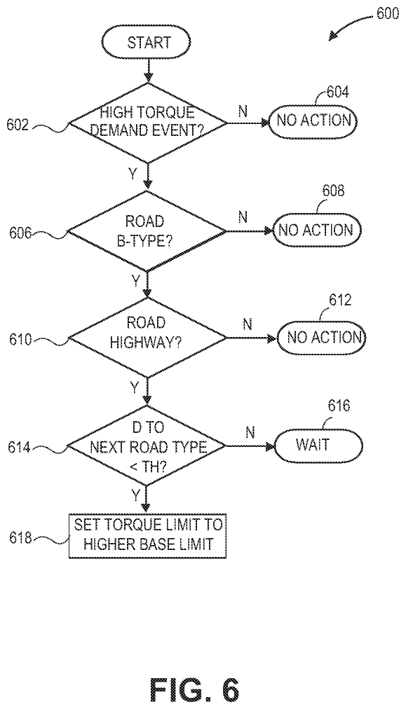

For one example, VCU 107 can also analyze map data 119 and sensor data from sensors 102 to detect contexts which are not low or high torque demand events such as a steady-state or stable condition. Such a condition can be vehicle 110 operating at a constant speed or unchanging in direction and motion. For example, a steady-state condition can include vehicle 110 operating in slow rush hour traffic after merging onto the highway or in cruise control operation mode where high torque or acceleration is not needed. In this steady-state condition, VCU 107 can change the torque limit back to the lower base limit, e.g., 100 Nm. For one example, VCU 107 can implement a state machine 500 in FIG. 5 and implement techniques and operations as described in FIGS. 4A-4B, 6 and 7A-7D for dynamic power savings.

FIG. 3B illustrates one example diagram of a contexts table 350 stored in memory 103 used by VCU 107. Contexts table 350 includes contexts 351 having a plurality of Contexts 1 to N that can identify and describe any number and types of contexts. Examples of contexts can be for low torque demand events 352 (e.g., vehicle entering an on-ramp) and high torque demand events 353 (e.g., vehicle merging on to highway from on-ramp). Each context 351 can have any number of parameters 354 in respective parameter sets 1 to N. Parameter sets 1 to N can include parameters related to vehicle location and speed, road type of location, speed limit of road for vehicle, traffic condition and sensor information to determine or identify a particular context. For example, parameters for a context such as merging onto an on-ramp can indicate that vehicle 110 is within 0.1 miles of an on-ramp or an image of an on-ramp is detected by sensors 102. For such a context, low torque demand 352 can be set to Y and the contexts 351 can be identified as “entering onto on-ramp.” Any number of contexts 351 can be stored in context table 350 with respective parameters 354 identifying the context and whether it is for a low torque demand event 352 or a high torque demand event 353. For other examples, a context 351 can be described that is neither a low or high demand event such as a steady-state or stable operation where vehicle 110 is operating at a constant speed or no changes are detected for vehicle 110.

Likewise, context 351 can include parameters 354 identify any number of contexts for a high torque demand event 353. Examples of contexts 351 for a high torque demand event 353 can include merging on highway from on-ramp, battery temperature exceeding a threshold, internal cabin temperature exceeding a threshold, kick-down pedal event etc. Parameters 354 can include any number of torque limits or intervals of varying torque limits to be used for low torque demand events 352 or high torque demand events 353. Parameters 354 can also be used in firmware or programs executed by the VCU 107 to implement dynamic power saving operations described herein.

FIG. 4A illustrates one example of a flow diagram of a dynamic power saving operation 400 in a mode for dynamic power savings or conservation. Operation 400 includes blocks 402 to 408. Initially, vehicle 110 is operating with torque limit for electric motor 108 is at its maximum base limit, e.g., 200 Nm or other value dependent on type of electric motor 108 and maximum torque available to electric motor 108.

At block 402, a mode is activated for dynamic power savings based on context data. The context data can include map data 119 having GPS information or data, and sensor data from sensors 102. For one example, VCU 107 can process the context data to determine a low torque demand event, e.g., approaching an on-ramp to a highway or off-ramp from the highway, where high acceleration is not needed. Alternatively, the mode for dynamic power saving can be activated manually by a user of vehicle 110, e.g., by pushing a button or control interface.

At block 404, once the mode is activated, VCU 107 can send control signals to electric motor 108 to change the torque limit from the maximum base limit to a lower base limit, e.g., 100 Nm or other value. For example, before entering the on-ramp, VCU 107 sets the torque limit to 100 Nm such that vehicle 110 does not exceed a torque on electric motor 108 beyond 100 Nm.

At block 406, a context for a high torque demand event is detected. For example, VCU 107 can process and analyze context data such as map data 119 having GPS information or data, and sensor data from sensors 102 to determine a high demand context, e.g., vehicle 110 leaving the on-ramp to merge onto the highway which may require high acceleration from electric motor 108 for vehicle 110 to merge onto the highway. Such contexts and parameters can be stored in contexts table 350 of FIG. 3B and used by VCU 107.

At block 408, if the high torque demand event is detected, VCU 107 can temporarily set the torque limit to the higher base limit, e.g., 200 NM or having interval of torque limits to read the higher base limit. In this way, if vehicle 110 is operating in the mode for dynamic power savings, the torque limit can be raised to events needing higher acceleration or torque for electric motor 108 such as merging onto a highway from the on-ramp.

FIG. 4B illustrates another example of a flow diagram of a dynamic power saving operation 410 in a power saving mode. Operation 410 includes blocks 412 to 416.

At block 412, the torque limit is set at the higher base limit in the mode for dynamic power saving. Block 412 can continue from block 408 in operation 400 of FIG. 4A.

At block 414, a low torque demand event is detected. For example, VCU 107 can process and analyze context data such as map data 119 having GPS information or data, and sensor data from sensors 102 to determine a low power demand context, e.g., vehicle 110 in rush hour traffic on the highway in which vehicle 110 is not moving or moving slowly. Other examples of low torque demand event contexts can include sensors 102 identifying speed limit signs from 15 mph to 25 mph such that low acceleration or torque is needed. Such contexts and respective parameters can be stored in contexts table 350 of FIG. 3B and used by VCU 107.

At block 416, if a low torque demand event is detected, VCU 107 can send control signals to electric motor 108 to reset the torque limit to the lower base limit, e.g., 100 NM. For other examples, VCU 107 can reset the torque limit from the higher base limit using intervals of lower base limits to reach 100 NM. Thus, vehicle 110 continues to operate in the mode for dynamic power savings using the lower base limit power consumption for electric motor 108.

FIG. 4C one example of a diagram of a highway with on-ramps and off-ramps and points for entering an on-ramp and leaving an off-ramp by a vehicle. For one example, a vehicle designated by “X” approaches an on-ramp at a point designated as “A.” The distance (D) can be a parameter 354 used by VCU 107 and stored in contexts table 350 to determine when to active a mode for dynamic power savings and lower a torque limit for a detected low torque demand event. For another example, a vehicle “X” is approaching a point designated as “B” to leave an off-ramp and merge onto a highway. A distance from X to B can also be a parameter in contexts table 350 of FIG. 3B determine to override the mode for dynamics power saving mode and temporarily raise the torque limit to a higher base limit for a detected high torque demand event.

### Exemplary Dynamic Power Saving State Machine and Operations

### State Machine

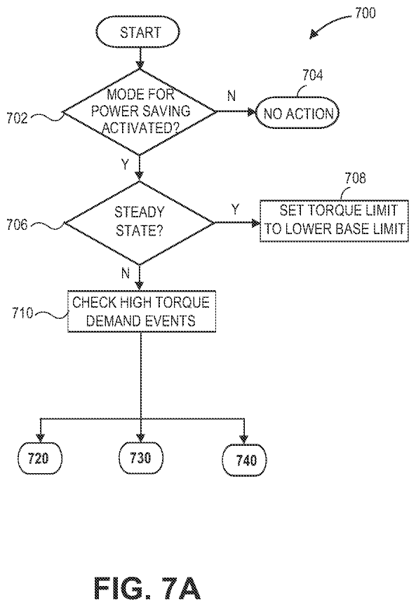

FIG. 5 illustrates one example of a block diagram of a dynamic power saving state machine 500. For one example, VCU 107 as described in FIGS. 1-3B can implement dynamic power saving state machine 500. Initially, vehicle 110 can start in the inactive state 502—i.e., the mode for dynamic power savings is not activated and the torque limit can be set at the maximum base limit, e.g., 200 NM. For one example, VCU 107 can enter into the active state 504 to activate or enter the mode for dynamic power savings based on context data or activated by a user. In active state 504, VCU 107 can perform operation 600 as described in FIG. 6 to change the torque limit from the maximum or higher base limit (e.g., 200 NM) to a lower base limit (e.g., 100 NM).

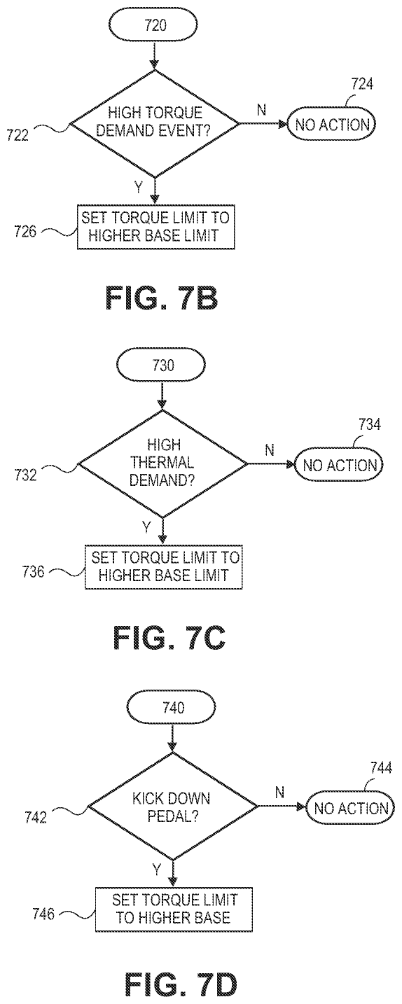

For one example, in the active state 504, VCU 107 can enter into the override state 506 if a high torque demand event is detected. For example, VCU 107 can use context data such as map data 119 having GPS information or data, and sensor data from sensors 102 to determine a high torque demand event such as, e.g., vehicle 110 at a location about to go up a hill or road with a steep incline. In the override state 506, VCU 107 can implement operation 700 as shown in FIGS. 7A-7D and override the mode for dynamic power savings by changing the torque limit from the lower base limit to the maximum base limit. If a low torque demand event is detected, e.g., VCU 107 using context data to determine that vehicle 110 is going down a hill where low torque is needed and can return back to the active state 504 and change the torque limit from the maximum base limit to the lower base limit. For one example, in the override state 506, VCU 107 can enter an inactive state 502 from a user of vehicle 110 or based on context data such as vehicle 110 starting to park or stop.

### Active State Operation

FIG. 6 illustrates one example of a flow diagram of an operation 600 of the dynamic power saving state machine of FIG. 5 in the active state 504 where the torque limit is set a lower base limit. Operation 600 includes blocks 602 to 618 which can be implemented by VCU 107 executing the dynamic power saving state machine 500.

At block 602, a check is made if a high torque demand event is detected. For example, VCU 107 can use context data (e.g., map data 119 having GPS information or data, and sensor data from sensors 102) to determine if vehicle 110 is approaching a highway from a secondary road or B-type road or from an on-ramp.

If N, at block 604, no action is taken.

If Y, at block 606, a check is made if the road vehicle 110 is on a secondary or B-type road, which can be any type of road that is not considered a highway. For example, VCU 107 can use context data to determine if vehicle 110 is on a secondary or B-type road.

If N, at block 608, no action is taken.

If Y, at block 610, a check is made to determine if the road type for vehicle 110 is a highway. When vehicle 110 is on or approaching a highway, the electric motor 108 may need a high acceleration or torque limit to reach speeds of 65 mph or more.

If no, at block 612, no action is taken.

If Y, at block 614, a check made if the distance (D) to the next road type is less than a threshold (TH). The distance D and threshold TH can be set by a user and be programmed and reconfigurable by VCU 107. If N, at block 616, VCU 107 enters into a wait state and can return back to block 614.

If Y, at block 618, VCU 107 can set the torque limit to the higher base limit. For example, if vehicle 110 just entered a highway the on-ramp, which a next road type, then vehicle 110 would be less than a threshold distance triggering the VCU 107 to raise the torque limit to the higher base limit.

The above operation 600 can be modified to accommodate for any type of high torque demands such a going up a hill or steep include and detecting different types of road types and characteristics and can use intervals of torque limits in raising the torque limits for a lower base limit to a higher base limit. For example, if going up a hill, the distance to the top of hill can be detected and if below a threshold, can set the torque limit to the higher base limit. Other examples can be contemplated and the dynamic power saving state machine 500 can be adjusted accordingly.

### Override State Operation

FIGS. 7A-7D illustrate example flow diagrams of an operation 700, 720, 730 and 740 of the dynamic power saving state machine 500 of FIG. 5 operating in the inactive state 506 where the torque limit is raised to the higher base limit. Operations 700, 720, 730 and 740 can be implemented by VCU 107 executing the dynamic power saving state machine 500.

Referring to FIG. 7A, at block 702, a check is made if power saving mode is activated.

If N, at block 704, no action is taken.

If Y, at block 706, a check is made if vehicle 110 is at a steady state such as vehicle 110 operating with no changing conditions or constant speed. For example, VCU 107 can use map data and sensor data to determine that vehicle 110 is in a steady state condition. Examples of steady state conditions can be vehicle 110 in slow or normal traffic or in a stop or non-moving position which can be detected by map data and sensor data.

If Y, at block 708, if in steady state condition, VCU 107 sets the torque limit for electric motor 108 to the lower base limit, e.g., 100 Nm, from the maximum base limit, e.g., 200 Nm.

If N, at block 710, a check is made for high torque demand events by performing operations 720, 730 and 740 illustrated in FIGS. 7B-7D.

Referring to FIG. 7B, operation 720 continues to block 722. At block 722, a check is made if a high torque demand event is detected. Examples of a high torque demand event is vehicle 110 being identified at or approaching a highway from an on-ramp or on or approaching a hill or road with steep inclined or by contexts 351 in contexts table 350 of FIG. 3B.

If N, at block 724, no action is taken.

If Y, at block 726, VCU 107 sets the torque limit to the higher base limit. This can be temporary such that once the high torque demand event is no longer detected or in steady-state, VCU 107 can return to the active state such that the mode for dynamic power savings is reactivated and the torque limit is reset back to the lower base limit.

Referring to FIG. 7C, operation 730 continues to block 732. At block 732, a check is made if a high thermal demand is detected. This can be a condition in which electrical demand from cooling exceeds a set limit for vehicle 110. Examples causing a high thermal demand events can be vehicle 110 moving up a steep hill or in deep snow which can be detected by sensors on vehicle 110.

If N, at block 734, no action is taken.

If Y, at block 736, VCU 107 sets the torque limit to the higher base limit.

Referring to FIG. 7D, at operation 740 continues to block 742. At block 742, a check is made if kick pedal is down. This can occur for a number of reasons. A user can be detected to have a health condition or emergency and steps on the acceleration pedal, and does not lift the pedal If detected, VCU 107 can set the torque limit to a lower limit or even have vehicle 110 reach a safe stop. VCU 107 can also detect that the acceleration pedal has been pressed to require a high acceleration such as when passing another vehicle.

If N, at block 744, no action is taken.

If Y, at block 746, VCU 107 sets the torque limit to the higher base limit.

The above operation 700 can be modified to accommodate for any type of high torque demand events and the above exemplary and not intended to be limiting. Other examples can be contemplated and the dynamic power saving state machine 500 can be adjusted accordingly.

In the foregoing specification, the invention has been described with reference to specific exemplary embodiments thereof. It will, however, be evident that various modifications and changes may be made thereto without departing from the broader spirit and scope of disclosed examples and embodiments. The specification and drawings are, accordingly, to be regarded in an illustrative rather than a restrictive sense.

1. A vehicle data processing system comprising:
a telematics subsystem configured to receive map data for a vehicle;
one or more sensors configured to receive sensor data related to the vehicle or user of the vehicle; and
a vehicle controller unit (VCU) coupled to the telematics subsystem and one or more sensors and configured to change a torque limit for an electric motor of the vehicle based on a context derived from the received map data or sensor data.

2. The vehicle data processing system of claim 1, wherein the VCU is configured to enter a mode for dynamic power saving and set the torque limit to a lower base limit from a higher base limit to conserve power consumption.

3. The vehicle data processing system of claim 2, wherein the VCU is configured to detect a high torque demand event and override the mode for dynamic power savings to temporarily set the torque limit back to the higher base limit.

4. The vehicle data processing system of claim 3, wherein the VCU is configured to reset the torque limit back to the lower base limit if the high torque demand event is no longer detected.

5. The vehicle data processing system of claim 1, wherein the context includes a vehicle location context based on the map data, a vehicle context based on sensor data from one or more sensors, or a user context based on sensor data from one or more sensors.

6. The vehicle data processing system of claim 5, wherein vehicle location context includes vehicle road location status, the vehicle context includes vehicle thermal status, and the user context includes kick down pedal status.

7. A vehicle comprising:
an electric motor coupled to a battery;
a telematics subsystem to receive map data and global positioning system (GPS) data for the vehicle;
one or more sensors receive sensor data related to the vehicle or user of the vehicle; and
a powertrain subsystem coupled to the electric motor, telematics subsystem and one or more sensors, the powertrain subsystem including a controller to change a torque limit for the electric motor based on a context derived from the received map data, GPS data or sensor data.

8. The vehicle of claim 7, wherein the controller enters a mode for dynamic power savings and set the torque limit to a lower base limit from a higher base limit to conserve power consumption by the battery to drive the electric motor.

9. The vehicle of claim 8, wherein the controller detects a high torque demand event and overrides the mode for dynamic power savings to temporarily set the torque limit back to the higher base limit.

10. The vehicle of claim 9, wherein the controller resets the torque limit back to the lower base limit if the high torque demand event is no longer detected.

11. The vehicle data processing system of claim 7, wherein the context includes a vehicle location context based on the map data or GPS data, a vehicle context based on sensor data from one or more sensors, or a user context based on sensor data from one or more sensors.

12. The vehicle of claim 11, wherein vehicle location context includes vehicle road location status, the vehicle context includes vehicle thermal status, and the user context includes kick down pedal status.

13. A method for a vehicle comprising:
entering into a mode for dynamic power savings based on a context derived from map data or sensor data; and
changing a torque limit for an electric motor of the vehicle from a maximum base limit to a lower base limit in the mode for dynamic power savings.

14. The method of claim 13, wherein entering into the mode for dynamic power savings includes detecting the context including at least one of a vehicle location context based on the map data, a vehicle context based on sensor data, and a user context based on sensor data.

15. The method of claim 14, wherein vehicle location context includes vehicle road location status, the vehicle context includes vehicle thermal status, and the user context includes kick down pedal status.

16. The method of claim 13, further comprising:
overriding the mode for dynamic power savings based on at least a high torque demand event derived from map data or sensor data; and
changing temporarily the torque limit for the electric motor of the vehicle from the lower base limit to the maximum base limit which is higher than the lower base limit.

17. The method of claim 16, further comprising:
detecting a low torque demand event; and
changing the torque limit from the maximum base limit to the lower base limit if the low torque demand event is detected.

18. The method of claim 17, wherein the high torque demand event includes driving situations requiring a high acceleration and the low torque demand event includes driving situations requiring a low acceleration.

19. The method of claim 13, further comprising:
rendering the mode for dynamic power savings inactive.

20. The method of claim 19, wherein a user activates or inactivates the mode for dynamic power savings.
